(19) United States
(12) Patent Application Publication
(10) Pub. No.: US 2024/0213660 A1
(43) Pub. Date: Jun. 27, 2024

(54) ANTENNA UNIT, ANTENNA MODULE AND MOTOR VEHICLE

(71) Applicant: Continental Automotive Technologies GmbH, Hannover (DE)

(72) Inventors: Guy-Aymar Chakam, Saal an der Donau (DE); Benjamin Becker, Sinzing (DE)

(73) Assignee: Continental Automotive Technologies GmbH, Hannover (DE)

(21) Appl. No.: 18/287,410

(22) PCT Filed: Feb. 18, 2022
(86) PCT No.: PCT/DE2022/200024

§ 371 Date: Oct. 18, 2023

(30) Foreign Application Priority Data
Apr. 19, 2021 (DE) 10 2021 203 835.2

(51) Int. Cl. H01Q 1/32; H01Q 1/12; H01Q 1/36; H01Q 7/00

(52) U.S. Cl. CPC H01Q 1/3275; H01Q 1/1214; H01Q 1/362; H01Q 7/00

(57) ABSTRACT

An antenna unit for an antenna module of a motor vehicle comprises an AM antenna and an FM antenna. The antenna unit comprises a DAB antenna, wherein the AM antenna and the FM antenna are formed as a combined AM-FM antenna having a common first antenna base, wherein the DAB antenna is formed at least partially as a part of the AM-FM antenna, which part is connected to a second antenna base assigned to the DAB antenna by way of a tap.

The invention relates to an antenna unit for an antenna module of a motor vehicle, wherein the antenna unit comprises an AM antenna, an FM antenna and a DAB antenna. The invention also relates to an antenna module having such an antenna unit, and to a motor vehicle having such an antenna module.

The networking of motor vehicles continues to increase. Whereas in the past antennas of motor vehicles were intended mainly for radio reception, today additional antennas have to be integrated. Such additional antennas are for example WLAN (Wireless Local Area Network) antennas, V-to-X antennas, telephone LTE (Long Term Evolution) 5G antennas for providing a mobile and/or Internet connection, and so on. It would be desirable here to be able to accommodate as many antennas as possible in the smallest possible module, such that such a module may be integrated for example on a vehicle roof, for example under a shark fin of the vehicle roof. However, the installation space available there is hugely limited. For example, such a shark fin must not be greater than 7 cm in height. This already poses major challenges for the integration of radio reception antennas, which are usually integrated elsewhere in the vehicle, such as for example in the rear window, due to their size.

The object of the present invention is therefore to provide an antenna unit, an antenna module and a motor vehicle that make it possible to integrate as many antennas as possible, comprising at least an AM-FM antenna and a DAB antenna, in an antenna unit in the most compact manner possible.

This object is achieved by an antenna unit, an antenna module and a motor vehicle having the features according to the respective independent patent claims. The dependent claims, the description and the figures relate to advantageous embodiments of the invention.

An antenna unit according to the invention for an antenna module of a motor vehicle in this case comprises an AM antenna and an FM antenna. The antenna unit furthermore has a DAB antenna, wherein the AM antenna and the FM antenna are formed as a combined AM-FM antenna having a common first antenna base, and wherein the DAB antenna is formed at least partially as a part of the AM-FM antenna, which part is connected to an antenna base assigned to the DAB antenna by way of a tap.

This has the major advantage that an AM antenna, an FM antenna and a DAB antenna are thus able to use common antenna components, as a result of which it is possible to provide a combined AM-FM-DAB antenna in the form of the antenna unit in an extremely small installation space. The AM antenna and the FM antenna may in this case advantageously be provided as a combined FM antenna to which only a single common base, namely the first antenna base, is assigned. The DAB antenna has its own second antenna base, but may nevertheless be provided as part of the AM-FM antenna, which is possible by virtue of said tap. This advantageously makes it possible to form an antenna unit with an AM antenna, an FM antenna and a DAB antenna in an extremely small volume. It is thus in particular possible to provide an antenna unit with a height less than 10 cm, in particular less than 7 cm, such that this may advantageously be integrated for example into a shark fin cover of a motor vehicle roof. This compact design of the antenna unit additionally makes it possible to accommodate even more antennas in such a small volume, for example in the form of a multiband and multifunctional antenna module, as will be described in more detail later.

An AM (amplitude modulation) antenna should in this case be understood to mean in particular an antenna that is designed to transmit and receive signals in the medium-wave range, in particular at around 0.5 MHz to around 2 MHz. Accordingly, an FM (frequency modulation) antenna is designed to receive and/or to transmit signals in the range of 87.5 MHz to 108 MHZ, and a DAB (digital audio broadcasting) antenna is designed to receive and/or to transmit signals in the range of 174 MHZ to around 240 MHz. Due to the different frequency ranges of AM and FM, there is no risk here of a negative effect on the reception quality. This may advantageously be used to design the extremely compact and at the same time efficient antenna unit.

In a further advantageous embodiment of the invention, the antenna unit has a winding part and a top-loading capacitance arranged above the winding part in a first direction, wherein the winding part is provided by helical antenna windings that are assigned to the AM-FM antenna and of which only a portion is assigned to the DAB antenna, which portion galvanically connects the top-loading capacitance and the remaining helical antenna windings to one another. The design of the AM-FM antenna and also of the DAB antenna with helical antenna windings allows the winding part of the antenna unit, that is to say the part of the antenna unit different from the top-loading capacitance, to be provided in a particularly compact manner. Due to the top-loading capacitance being part of the AM-FM antenna and of the DAB antenna, the design of the antenna unit may be made even smaller. This means that the antenna unit may thus be designed in two parts, with one part being provided by the top-loading capacitance and the other part being provided by the corresponding helical antenna windings, wherein both the top-loading capacitance and these helical antenna windings may in turn advantageously be used at least partially jointly by the DAB antenna and the AM-FM antenna.

There are also numerous options for forming the top-loading capacitance. This may be implemented for example in the form of a mounted, for example punched or deep-drawn metal sheet, or in the form of an adhesively bonded film on a carrier. It may also be printed on a carrier. This carrier may for example constitute a protective cap in which the module components of an antenna module comprising the antenna unit are arranged, as will be explained later.

In a further advantageous embodiment of the invention, that portion of the helical antenna windings assigned to the DAB antenna is coupled to the top-loading capacitance via an electrically conductive connecting element that is designed to provide tolerance compensation in the first direction.

This advantageously makes it possible to arrange the top-loading capacitance, for example as already mentioned above, on a carrier, wherein, when this carrier is arranged relative to the winding part of the application device, tolerance compensation is advantageously made possible by the connecting element, which simplifies mounting significantly. Small manufacturing and assembly tolerances between the winding part and the carrier on which the top-loading capacitance is arranged may thus advantageously be provided by the connecting element that establishes the electrical connection between the top-loading capacitance and the winding part of the antenna unit. There are then in turn numerous options for the design of such a connecting element. Preferably, the coupling is achieved via a spring or a contact foam as such a connecting element. Such a contact foam may then for example comprise metallic particles in order to be electrically conductive. Contact between the top-loading capacitance and the AM-FM-DAB antenna may however also be created differently, for example by clamping.

If for example the antenna unit is arranged in its intended installation position on a motor vehicle, then the first direction preferably corresponds substantially to a vehicle upright direction. However, generally speaking, the first direction may also be defined as being oriented substantially parallel to the direction of gravity and counter to gravity. This means that the top-loading capacitance is thus advantageously the highest component of the antenna unit, which maximizes reception quality. The helical antenna windings used jointly by the DAB antenna and the AM-FM antenna are then accordingly arranged underneath, and the helical antenna windings assigned exclusively to the AM-FM antenna are in turn arranged below them. The first and the second base for the AM-FM antenna and the DAB antenna may then accordingly be arranged underneath the helical antenna windings. The antenna in question may be coupled to a transceiver unit via this base. This arrangement advantageously allows the top-loading capacitance to be used jointly by the DAB antenna and the AM-FM antenna.

In a further highly advantageous embodiment of the invention, the antenna unit has a circuit board having a height in a first direction and a width in a second direction perpendicular to the first direction, wherein the helical antenna windings of the AM-FM antenna and DAB antenna, formed at least partially as a planar helical antenna, are arranged on the circuit board, and wherein the helical antenna windings run at least predominantly in the second direction. The combined AM-FM antenna and also the DAB antenna may thus advantageously be formed as a respective planar helical antenna on a circuit board, that is to say with the exception of the top-loading capacitance. The AM-FM antenna and the DAB antenna, that is to say their respective winding parts, are accordingly advantageously implemented on a common circuit board, which saves on installation space and material. Another major advantage of the described embodiment is that the helical antenna windings run at least predominantly in the second direction. Specifically, this has the major advantage that it is thereby possible to arrange a further antenna, for example an LTE 5G telephone antenna, as explained in more detail later, very close to the antenna unit, and at the same time to ensure the best possible decoupling from this additional antenna. By way of example, the circuit board of this additional antenna may be oriented perpendicular to the circuit board of the antenna unit, thereby making it possible to maximize decoupling.

A further highly advantageous embodiment of the invention is therefore when a gradient of the course of the helical antenna windings with respect to a plane perpendicular to the first direction is less than a predetermined limit value, which is preferably at most 5°, particularly advantageously at most 3°, for example 2.2°. The decoupling from other antennas is thereby able to be maximized.

In a further advantageous embodiment of the invention, the AM-FM antenna has a higher efficiency in a specific first frequency range than in a specific second frequency range, wherein the DAB antenna has a lower efficiency than the AM-FM antenna in the first frequency range and a lower efficiency than in the second frequency range, in which the DAB antenna also has a higher efficiency than the AM-FM antenna. This may be provided for example by a suitable geometric design of the AM-FM antenna and of the DAB antenna. Due to these different frequency ranges, it is possible to provide natural decoupling of the DAB antenna from the AM-FM antenna. The DAB antenna is in this case preferably designed such that it has a series and parallel resonance within the DAB frequency band, that is to say the second frequency range, while the AM-FM antenna is designed such that it has only a series resonance within the FM frequency band, that is to say generally the first frequency range. In addition, the FM antenna has a significantly lower efficiency at the base at least in a subregion of the DAB band, as a result of which it is possible to provide natural decoupling from the DAB antenna at least in a subregion of the DAB band. This requires it to be designed by placing the parallel resonance of this AM-FM antenna close to the beginning of the DAB band. The DAB antenna, on the other hand, has a lower efficiency in the FM band. This may be provided for example by its size and optional decoupling measures on the common circuit board, such as for example at least one slot, preferably in the first direction.

A further highly advantageous embodiment of the invention is therefore when the tap is designed as an electrically conductive element on the circuit board that runs counter to the first direction from the windings assigned to the DAB antenna to the second antenna base and is arranged next to the helical antenna windings assigned exclusively to the AM-FM antenna in the second direction, wherein a slot running in the first direction is arranged at least in regions between the electrically conductive element and the helical antenna windings assigned exclusively to the AM-FM antenna in the circuit board. This makes it possible to further increase the decoupling between the DAB antenna and the AM-FM antenna. The slot width in the second direction may be provided depending on the available installation space, and for example be one or more millimeters.

The invention furthermore also relates to an antenna module having an antenna unit according to the invention or one of its embodiments. The advantages mentioned for the antenna unit according to the invention and its embodiments thus apply analogously to the antenna module according to the invention.

It should also be noted here that the antenna unit according to the invention and its embodiments or the antenna module according to the invention and its embodiments are preferably used on a motor vehicle, but the use of the antenna unit or the antenna module should not be limited to the field of motor vehicles. Such an antenna module or the antenna unit according to the invention or one of its embodiments may be used in principle anywhere and especially advantageously wherever an AM-FM-DAB antenna needs to be designed in an extremely compact manner, and for example wherever a large number of antenna functions need to be provided in the smallest possible installation space.

The antenna module may furthermore have for example a protective cover that is arranged above the circuit board in the first direction, wherein the top-loading capacitance is arranged above the protective cover in the first direction. By way of example, the top-loading capacitance may be arranged on the protective cover as carrier. However, the top-loading capacitance may also be integrated in an outer cover, which may be provided for example by a shark fin of the motor vehicle, which is in turn arranged above the protective cap. The protective cover in this case advantageously has the function of protecting the module components of the antenna module, on the one hand, and of acting at the same time as carrier for the top-loading capacitance, on the other hand. This dual function may in turn favor the most compact design possible of the antenna module.

Furthermore, the antenna module may also comprise a main circuit board to which the DAB antenna and the AM-FM antenna are connected, in particular at their respective bases. The circuit board of the AM-FM-DAB antenna may for example be arranged directly on this main circuit board or be at least electrically conductively connected thereto. This main circuit board may for example be oriented substantially parallel to the vehicle roof when the antenna module is arranged as intended on the motor vehicle.

In addition, it is highly advantageous when the antenna module for example comprises at least one further antenna. Such a further antenna may be designed for example as an LTE 5G telephone antenna and/or as a GNSS (global navigation satellite system) antenna and/or as a V-to-X antenna and/or WLAN antenna and/or UWB antenna. In principle, there is additionally the option to arrange antennas on a first side in relation to the main circuit board and also on a second side of the main circuit board, which second side is arranged opposite the first side. By way of example, the first side may be directed outwardly in relation to the intended installation position on the motor vehicle, and the second side may be directed accordingly toward the vehicle interior. The antenna unit is then accordingly preferably arranged on the first side of this main circuit board, as is preferably at least one, preferably two, particularly preferably four LTE 5G telephone antennas. An external arrangement makes it possible to improve reception. By taking advantage of the fact that antennas may however also be arranged on the inner side, that is to say on the second side of the main circuit board, it is possible to accommodate significantly more antennas in the antenna module in an extremely compact manner.

An LTE 5G telephone antenna should in this case generally be understood to mean an antenna designed to transmit and receive signals according to a mobile radio standard, in particular according to the LTE (Long Term Evolution) standard and 5G standard and optionally also the 4G standard and/or GSM standard. The more such LTE 5G telephone antennas are provided, the higher the data transmission rates able to be attained. This is also referred to as MIMO (Multiple In Multiple Out), because information to be transmitted may be transmitted and received proportionately in parallel by multiple antennas. This means that more antennas are also able to provide communication according to a radio standard having higher data transmission rates, for example 5G. For example, two such antennas may be used to provide communication according to the 4G standard, and four such antennas may be used to provide communication according to the 5G standard. The term LTE 5G telephone antenna should thus be understood in the present case to mean that these LTE 5G telephone antennas may be used for communication according to the 5G standard, but not that a single such antenna would already be sufficient for this purpose. However, mobile communication at lower data transmission rates than the 5G standard may already also be provided using a single such LTE 5G telephone antenna.

Such an LTE 5G telephone antenna may likewise be implemented on a circuit board. This is then accordingly preferably oriented perpendicular to the circuit board of the AM-FM-DAB antenna in order to enable maximum decoupling. In addition, it is preferable that at least one first LTE 5G telephone antenna has two antenna arms that are not galvanically connected to one another, but rather are only capacitively coupled to one another. An arm for higher frequencies greater than 1 GHz may thus excite the arm for the lower frequencies less than one GHz via this capacitive coupling. This capacitive coupling additionally makes it possible to maximize the decoupling from the AM antenna of the antenna unit. This allows this first LTE 5G telephone antenna to be arranged particularly close to the antenna unit. As described, it is also preferable that at least a second LTE 5G telephone antenna is provided on the first side of the main circuit board as part of the antenna module. This may for example be arranged as far away as possible from the first LTE 5G telephone antenna, in particular in relation to the second direction, in order to provide maximum decoupling therefrom. In addition, it is preferable that the circuit boards of these two LTE 5G telephone antennas are aligned perpendicular to one another in order to further increase this decoupling and use the installation space more efficiently. By way of example, the antenna unit may be arranged between the first and the second LTE 5G telephone antenna. Furthermore, a GNSS antenna may be arranged between the second LTE 5G telephone antenna and the antenna unit, along with optionally two further LTE 5G telephone antennas as well. In addition, one or two V-to-X antennas may also be integrated into the first and the second LTE 5G telephone antenna, that is to say be arranged on the same circuit board. A V-to-X antenna, or also called Car2X antenna, is used here for communication between the vehicle and another vehicle or any other communication-capable device, for example according to the WLANp standard. Due to their typical bandwidth, there is no significant risk of coupling with other antennas. The antennas able to be additionally provided on the second side of the main circuit board may in this case constitute for example an eCall antenna, a WLAN (Wireless Local Area Network) antenna and/or a UWB (Ultra-Wideband) antenna. Thus, advantageously, numerous further antennas may be arranged underneath the main circuit board, as it were, and thus in an interior of the motor vehicle, or be arranged facing the interior of the motor vehicle. Optionally, further electrical and/or electronic components, such as for example tuners, transceivers, receivers, control units or the like may for example also be provided and integrated in such an antenna module, in particular likewise preferably on the second main circuit board.

The invention furthermore also relates to a motor vehicle having an antenna module according to the invention or one of its embodiments.

It is preferable here that the antenna module is arranged at least partially on a motor vehicle roof of the motor vehicle, in particular under a shark fin cover of the motor vehicle roof. Particularly good reception is possible precisely at this location, and the invention additionally provides the option of also providing numerous different antennas and antenna functions in such a limited installation space.

The antenna module may furthermore be coupled to the vehicle roof in a wide variety of ways. It is preferable here that the antenna module has a good galvanic connection to the roof that is able to be achieved without screws or with the aid of one or more screws. This galvanic connection makes it possible to establish a ground connection to the roof. The roof antenna module, that is to say the antenna module arranged on the motor vehicle roof, may also be formed in one part or else two parts, as will be explained later with reference to the figures. In all cases, however, the antennas have at least one electrical contact with the main circuit board in order to enable a connection to the receivers and transceivers. These may likewise in this case be integrated into the antenna module or else be arranged at a distance therefrom.

Since the invention and its embodiments advantageously make it possible to provide an antenna module in an extremely small installation space with numerous antennas, it is particularly advantageous to accommodate this antenna module in a roof area of the motor vehicle under the outer cover, that is to say the shark fin, of the motor vehicle. Said protective cap is then accordingly located underneath this outer cover. The top-loading capacitance may then be arranged for example on the protective cap or else integrated into the outer cover.

The invention also comprises the combinations of the features of the described embodiments.

An exemplary embodiment of the invention is described below, in which regard:

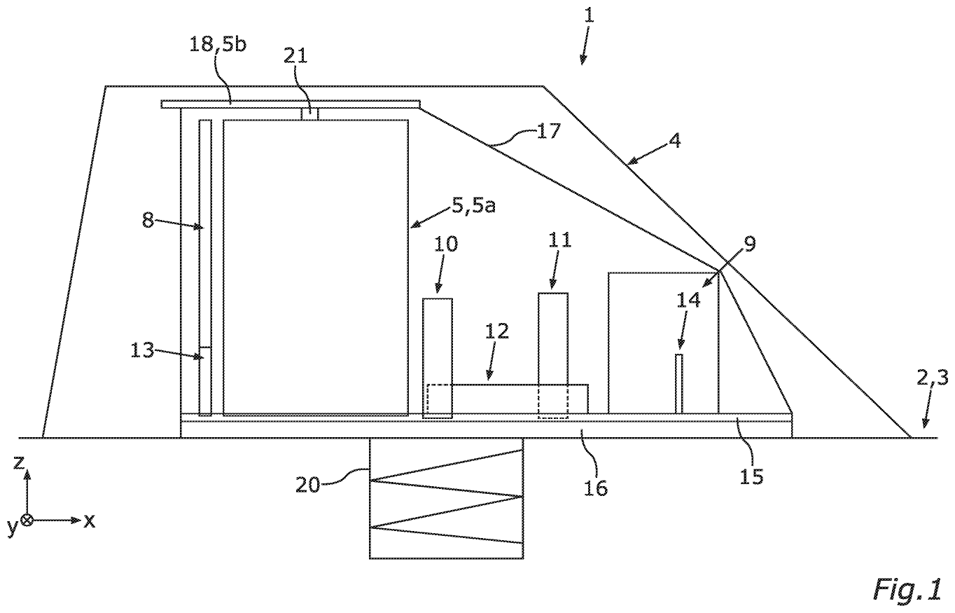

FIG. 1 shows a schematic illustration of an antenna module having an antenna unit according to one exemplary embodiment of the invention;

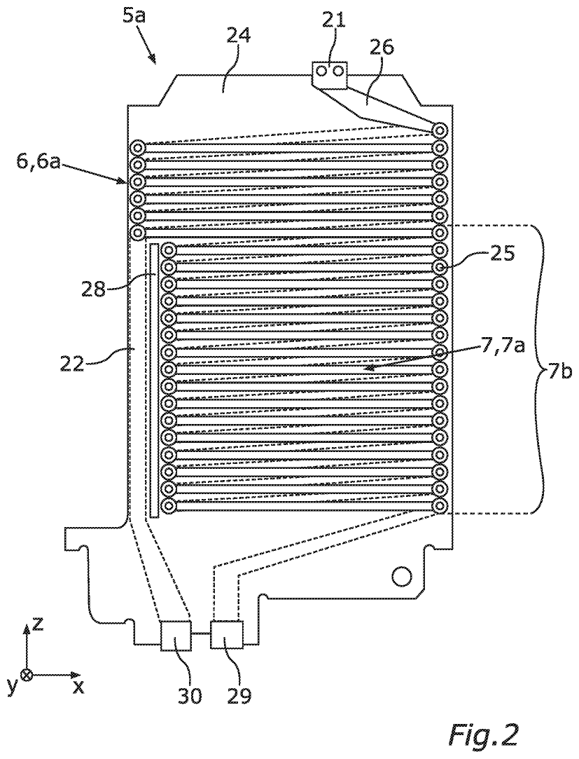

FIG. 2 shows a schematic illustration of the connecting part of an antenna unit according to one exemplary embodiment of the invention;

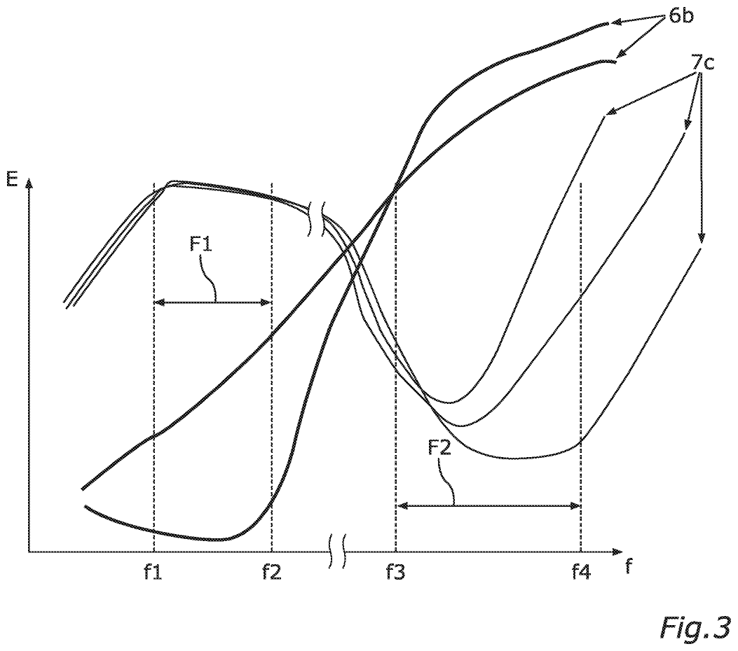

FIG. 3 shows a schematic illustration of the curves of efficiency as a function of frequency for the DAB antenna and the AM-FM antenna according to one exemplary embodiment of the invention; and

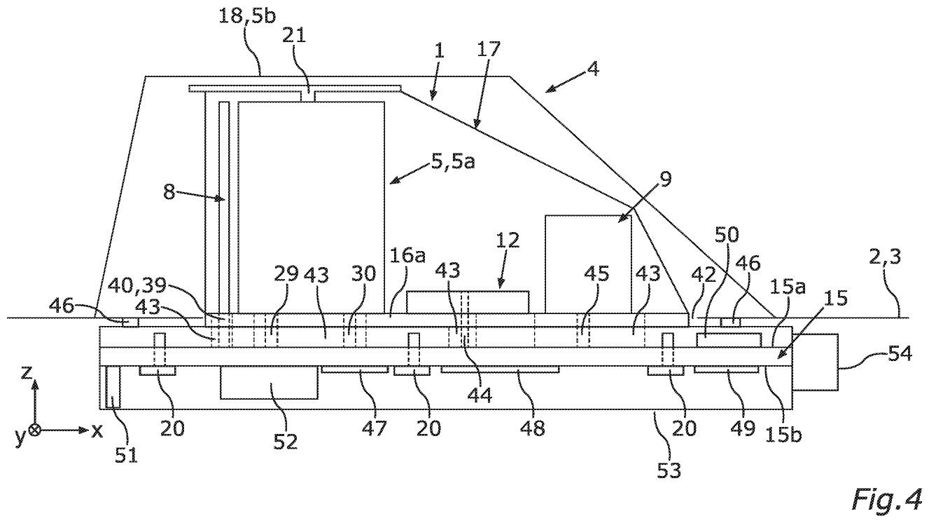

FIG. 4 shows a schematic illustration of an antenna module having an antenna unit according to a further exemplary embodiment of the invention.

The exemplary embodiments explained below are preferred embodiments of the invention. In one exemplary embodiment, the described components of the embodiment each represent individual features of the invention that should be considered independently of one another and that each also develop the invention independently of one another and may therefore also be considered to be part of the invention individually or in a combination other than that shown. Furthermore, the embodiment described may also be supplemented by further features of the invention that have already been described.

In the figures, elements with the same function are each provided with the same reference signs.

FIG. 1 shows a schematic illustration of an antenna module 1 for a motor vehicle 2, of which the vehicle roof 3 and the outer cover 4 mounted on the vehicle roof 3, which is also referred to as shark fin, are illustrated purely by way of example. The antenna module 1 here is formed by way of example as a multifunctional and multiband antenna module 1 in a very small installation space. The antenna module 1 in this case comprises an antenna unit 5 according to one exemplary embodiment of the invention. This antenna unit 5 is also referred to as AM-FM-DAB antenna 5, since it comprises both a DAB antenna 6 and a combined AM-FM antenna 7 (see FIG. 2). In addition to this antenna unit 5, which is explained in more detail later, the antenna module 1 in this example additionally has a first LTE 5G telephone antenna 8, which is arranged on another antenna unit 5. In addition, in this example, the antenna module 1 also comprises a second LTE 5G telephone antenna 9, a third and fourth LTE 5G telephone antenna 10, 11, a GNSS antenna 12 and two V-to-X antennas 13, 14. These antenna module components are arranged in this case on a main circuit board 15, which in turn is arranged on a carrier 16, which may also be referred to as chassis. Furthermore, a protective cover 17 is arranged at least over most of these antenna module components. With the exception of a top-loading capacitance 18 assigned to the antenna unit 5, all other antennas are arranged under this protective cover 17. Furthermore, this antenna module 1 may be mounted on the roof of the motor vehicle via a screw connection 20. In this example, no tuner or transceiver, receiver and so on is integrated into the antenna module 1. Further examples having integrated receivers, tuners, receivers, and so on will be explained in more detail later with reference to FIG. 4. The invention and its embodiments advantageously make it possible to provide an extremely compact antenna module 1, in which the highest antenna provided by the antenna unit 5 is smaller than 10 cm in the first direction, corresponding to the z-direction illustrated here, in particular measures only around 7 cm in the first direction. With reference to the intended installation position of this antenna module 1 in relation to the motor vehicle 2, the z-direction moreover corresponds here to the vehicle upright direction, the x-direction illustrated here corresponds to the vehicle longitudinal direction, wherein the x-direction in particular points toward the vehicle front and the y-direction points in the vehicle transverse direction. The z-direction is, inter alia, also referred to as first direction, the y-direction is referred to as third direction, and the x-direction is referred to as second direction. In addition, the AM-FM-DAB antenna 5 is placed in the highest area of the roof module 1, and the AM-FM-DAB antenna is additionally implemented in two parts. A first part 5a is located in this case underneath the protective cap 17, and the second part 5b represents the already mentioned top-loading capacitance 18. The top-loading capacitance 18 of the AM-FM-DAB antenna 5 may in this case, as illustrated, be arranged on the protective cap 17 or else integrated in the outer cover 4, that is to say the shark fin. The top-loading capacitance 18 makes contact with the first part 5a of the AM-FM-DAB antenna 5 by way of a contact element 21, which preferably represents a spring or an electrically conductive foam material. The contact, that is to say the contact element 21, with the first part 5a of the AM-FM-DAB antenna 5 may also be implemented differently, for example by clamping. Furthermore, this top-loading capacitance 18 may be implemented in the form of a mounted, for example punched or deep-drawn metal sheet or adhesively bonded film. It may also be printed on the protective cap 14. In the event that the top-loading capacitance 18 is a film, this may have a conductor track structure or be designed as a resonant conductor track structure.

The first part 5a of the antenna unit 5 is implemented as an upright PCB (printed circuit board) antenna. This first part 5a of the AM-FM-DAB antenna 5 is illustrated again in detail in FIG. 2.

FIG. 2 in this case shows a schematic illustration of a top view of a first side of the winding part 5a of the antenna unit 5 according to one exemplary embodiment of the invention. Both the DAB antenna 6 and the AM-FM antenna 7 are designed in this case with helical antenna windings 6a, 7a, which are arranged on a circuit board 24. By way of example, the thickness of this circuit board in the y-direction may be between 0.5 mm and 2 mm, and is 1 mm in this example. The individual helical antenna windings 6a, 7a may in this case be applied as conductor tracks on this circuit board 24, wherein the individual front and rear conductor track sections are connected to one another by corresponding vias 25, of which, for the sake of clarity in FIG. 2, only one is provided with a reference sign. This planar helical antenna 6, 7 is thus provided in the form of a flat-pressed coil, as it were, having a plurality of windings arranged one above the other in the z-direction. Furthermore, in this example, the helical antenna windings 6a, 7a running substantially horizontally or parallel to the x-y plane on the first side are illustrated with solid lines, and the helical antenna windings 6a, 7a running on the rear of the circuit board 24, which have a gradient that is as low as possible in relation to the x-y plane here, are illustrated with dashes. The gradient is preferably 3 degrees at most.

It is then particularly advantageous that a portion 6a of these helical antenna windings 7a that are assigned to the AM-FM antenna 7 may be used simultaneously for the DAB antenna 6. In other words, the entire set of illustrated helical antenna windings is denoted by 7a, and these represent the helical antenna windings 7a used by the AM-FM antenna, while 6a denotes the helical antenna windings that are additionally also used by the DAB antenna 6 or provide part thereof. The helical antenna windings that are used exclusively by the AM-FM antenna 7 are denoted by 7b here.

Furthermore, the helical antenna windings 6a, 7a of the AM-FM-DAB antenna 5 are galvanically connected to the top-loading capacitance 18 via the coupling element 21, wherein this galvanic connection is denoted by 26 here.

The AM antenna and the FM antenna, which are provided here as a combined AM-FM antenna 7, accordingly have a common first antenna base 29. The DAB antenna 6 has its own second antenna base 30. These bases 29, 30 are electrically connected to the main circuit board 15 (see FIG. 1).

The DAB antenna 6 is thus provided by virtue of the helical antenna windings 6a assigned to the DAB antenna 6 being electrically conductively connected to the second base 30 via a tap 22. This tap 22 may be implemented as an electrically conductive connection arranged on the circuit board 24 and running substantially in the z-direction. In order to improve the decoupling of the DAB antenna 6 from the AM-FM antenna 7, it is furthermore advantageous when a slot, or in this example a through-opening 28 likewise running in the z-direction, is arranged between this tap or this electrically conductive connection 22 and the helical antenna windings 7b assigned exclusively to the AM-FM antenna 7. Due to the design of the antenna parts 6a, 7a as planar helical antenna windings 6a, 7a, these windings 6a, 7a also have barely any extent in the y-direction. Due to the fact that the individual helical antenna windings 6a, 7a are as flat as possible in relation to the x-y plane, the electrically conductive components of the antenna unit 5 running in the z-direction may be reduced to a minimum. This enables maximum decoupling from adjacently arranged antennas, especially from the first LTE 5G telephone antenna 8 (see FIG. 1).

In order furthermore to provide the best possible decoupling between the DAB antenna 6 and the FM antenna 7, it is additionally advantageous when these are designed to be optimized for different frequency ranges with regard to their efficiency, also called antenna gain, as illustrated in FIG. 3. Here, FIG. 3 illustrates by way of example three curves 7of efficiency E for the AM-FM antenna 7, and by way of example two possible curves 6b of efficiency E for the DAB antenna 6, each as a function of frequency f. As may be seen, the FM antenna 7 preferably has a significantly higher efficiency E in a first frequency range F1 than, on the one hand, the DAB antenna 6 and, on the other hand, than the FM antenna 7 in a second frequency range F2, in which their efficiency E is preferably significantly lower than that of the DAB antenna 6. The first frequency range F1 in this case corresponds to the FM frequency range and is limited for example by the lower limit frequency f1 and the upper limit frequency f2. f1 may for example be 87.5 MHz and f2 may for example be 108 MHZ. The second frequency range F2 represents the DAB frequency range and extends from a third frequency f3 to a fourth frequency f4. The third frequency f3 may for example be 174 MHZ, and the fourth frequency f4 may for example be 240 MHz. To achieve this, the corresponding antennas 6, 7 may be designed suitably with regard to their geometry. Due to the geometric properties of an antenna, it is possible to influence in particular series and parallel resonance of the corresponding antennas. The DAB antenna 6 is in this case preferably designed such that it has a series and parallel resonance within the DAB frequency band F2. The parallel resonance of the AM-FM antenna is preferably placed near the beginning of the DAB band F2. This makes it possible to provide natural decoupling. The fact that the DAB antenna 6 has a lower efficiency in the FM band F1 is provided by geometric properties, on the one hand, such as its length, and, on the other hand, additionally by the provision of slots, such as for example the slot 28 already described in FIG. 2.

These embodiments advantageously make it possible to provide the antenna unit 5 with integrated AM-FM antenna 7 and integrated DAB antenna 6 in an extremely compact, small installation space, and nevertheless enable a very good reception quality of these antennas.

FIG. 4 in this case shows an antenna module 1 according to a further exemplary embodiment of the invention. Moreover, this antenna module 1 may be designed as described above, with the exception of the differences explained below. In particular, this antenna module 1 may likewise have the antennas explained in FIG. 1, even though the third and fourth LTE 5G telephone antenna 10, 11 is not illustrated here by way of example. The two V-to-X antennas 13, 14 are not illustrated here either, but may nevertheless be part of this antenna module 1. The antennas already mentioned in FIG. 1 are arranged here on a first side 15a of the main circuit board 15, wherein components that will likewise be explained in even more detail later may also be arranged on the opposite side 15b of this main circuit board 15. The antenna module 1 is designed in this example according to a single-part mounting concept, according to which this assembled antenna module 1 may be inserted through a hole or a through-opening 42 in the vehicle roof 3 and mounted from below in one piece. In other words, in this example, the roof antenna module 1 may only be mounted from inside the vehicle. In this case, only the external part of the module 1, that is to say those components that are located above the chassis or carrier element 16a, is inserted through the cutout 42. The individual antennas and components of the antenna module 1 that are inserted through may in this case be mounted again via the separate carrier element 16a, a chassis, which is fixedly connected to the inner part of the antenna module 1. This carrier element 16a has, for each antenna, a corresponding opening 43 through which the bases 29, 30, the AM-FM antenna 7 and the DAB antenna 6, as well as the bases 39, 40, 44, 45 of the other antennas pass in order to ensure electrical contact between each antenna and the main circuit board 15. In this case, 39 denotes a ground contact of the first LTE 5G telephone antenna 8 for antenna detection, 40 denotes the base of the first LTE 5G telephone antenna 8, 44 denotes the base of the GNSS antenna 12 and 45 denotes the base of the second LTE 5G telephone antenna 9. This antenna module 1 may be connected to the roof 3 of the vehicle 2 in this case via a metallized foam 46. This may in turn at the same time provide tolerance compensation in the z-direction. At least the antennas located on the first side 15a of the main circuit board 15 are in this case, in particular like the GNSS antennas 12 in this example, all oriented perpendicular to the main circuit board 15 and designed as respective PCB antennas. It is additionally particularly advantageous in this case that the circuit board 24 of the antenna unit 5 is perpendicular to a circuit board of the first LTE 5G telephone antenna.

The main circuit board 15 may in turn be fastened to the carrier element 16a via corresponding screw connections 20.

The second LTE 5G telephone antenna 9 is furthermore preferably oriented perpendicular to the first LTE 5G telephone antenna 8 in order to provide maximum decoupling therefor. If further LTE 5G telephone antennas 10, 11 are provided, as illustrated for example in FIG. 1, then these are in turn preferably oriented parallel to the first LTE 5G telephone antenna 8.

In this example, the GNSS antenna 12 is designed as a patch antenna. It is therefore very flat in relation to the z-direction and has a circular radiation characteristic, which is predominantly directed vertically upward, that is to say in the z-direction. In order to reduce possible shielding by the top-loading capacitance 18, provision may however also be made to instead design this GNSS antenna 12 as a PCB antenna as well, that is to say with a circuit board that is in turn preferably oriented perpendicular to the main circuit board 15. On such a circuit board, the GNSS antenna 12 may be designed as a dipole-like antenna, for example in the form of a downwardly open arc or a downwardly open parabola, with a capacitive infeed. The maximum height available in the z-direction below the protective cap 17 may in this case be used to implement this GNSS antenna 12. Such a dipole-like antenna solution advantageously likewise makes it possible to provide a main radiation direction in the z-direction, or a corresponding reception characteristic. In contrast to the patch antenna 12 illustrated here, such a dipole-like antenna solution is designed only for the transmission of linearly polarized signals. Such a dipole-like antenna solution with a capacitive infeed makes it possible to achieve decoupling of this antenna in the GNSS band and an AM function.

In this example, the antenna module 1 additionally also has receivers or transceivers 47 and a tuner 48. Furthermore, the antenna module may also comprise a control unit 49 and a power supply 50. These components may be arranged directly on the main circuit board 15, in particular on the second side 15b thereof, but also in part on the first side 15a. Furthermore, yet more antennas are provided on the second side 15b of the main circuit board 15, such as for example a WLAN antenna 51 and a backup E-call antenna 52. Although only one receiver 47 is illustrated by way of example here, a plurality thereof may however be arranged on the main circuit board 15. The following components are especially advantageous: An LTE 5G telephone transceiver, a radio tuner, a GNSS receiver, a WLAN transceiver and a V-to-X receiver, in particular for each V-to-X antenna 13, 14, if present. All of these receivers and transceivers are preferably integrated in the lower box 53 on the main circuit board 15. All of the antennas also have at least one electrical contact with the main circuit board 15 to ensure a connection to the receivers and transceivers. The antenna module may also have at least one or more digital interfaces or at least one connector 54, via which the antenna module 1 is able to be coupled to a vehicle bus, for example a CAN bus, Ethernet, a FlexBus and so on.

As an alternative, the antenna module 1 may also be designed according to a two-part concept, but this is not illustrated explicitly here. However, this requires only a slight modification. By way of example, the main circuit board 15 could be designed in two parts, such that a part of this main circuit board 15 or a first main circuit board 15 is assigned to the components arranged on the first side 15a, and the second part of the main circuit board 15 or a second main circuit board 15 is assigned to the components arranged on the second side 15b. The upper part of the antenna module 1 could then be mounted accordingly on the roof 3 from above, and the lower part of the antenna module 1 could be mounted from below. An additionally provided connector could electrically conductively connect these two parts of the main circuit board 15 or the two main circuit boards 15 through the roof 3. Such a connector may accordingly comprise the individual connecting lines for the components arranged above the vehicle roof 3.

Overall, the examples show how the invention is able to provide an integrated, electrically very small AM-FM-DAB antenna smaller than 100 mm with a tap for DAB, which enables a compact technical solution for an integrated AM-FM-DAB antenna, especially for roof antenna systems for motor vehicles. These may be designed both as a conventional antenna module without tuner and transceiver integration and as an intelligent, multifunctional roof antenna module having an integrated AM-FM-DAB antenna for providing a “remote radio”. In addition, telephone and data services may also be integrated.

1. An antenna unit for an antenna module of a motor vehicle, the antenna unit comprising: an AM antenna, an FM antenna, and a DAB antenna, wherein the AM antenna and the FM antenna are formed as a combined AM-FM antenna having a common first antenna base, wherein the DAB antenna is formed at least partially as a part of the AM-FM antenna, which part is connected to a second antenna base assigned to the DAB antenna by way of a tap.

2. The antenna unit as claimed in claim 1, wherein the antenna unit comprises a winding part and a top-loading capacitance arranged above the winding part in a first direction, wherein the winding part is provided by helical antenna windings that are assigned to the AM-FM antenna and of which only a portion is assigned to the DAB antenna, said portion galvanically connecting to one another the top-loading capacitance and the helical antenna windings assigned only to the AM-FM antenna.

3. The antenna unit as claimed in claim 2, wherein that portion of the helical antenna windings assigned to the DAB antenna is coupled to the top-loading capacitance via an electrically conductive connecting element configured to provide tolerance compensation in the first direction.

4. The antenna unit as claimed in claim 2, wherein the antenna unit comprises a circuit board having a height in a first direction and a width in a second direction perpendicular to the first direction, wherein the helical antenna windings of the AM-FM antenna and DAB antenna, formed at least partially as a planar helical antenna, are arranged on the circuit board, and wherein the helical antenna windings run at least predominantly in the second direction.

5. The antenna unit as claimed in claim 2, wherein a gradient of a course of the helical antenna windings with respect to a plane perpendicular to the first direction is less than a predetermined limit value of at most 5°.

6. The antenna unit as claimed in claim 1, wherein the AM-FM antenna has a higher efficiency in a specific first frequency range than in a specific second frequency range and wherein the DAB antenna has a lower efficiency than the AM-FM antenna in the first frequency range and a lower efficiency than in the second frequency range, in which the DAB antenna also has a higher efficiency than the AM-FM antenna.

7. The antenna unit as claimed in claim 2, wherein the tap configured as an electrically conductive element on a circuit board that runs counter to the first direction from the helical antenna windings assigned to the DAB antenna to the second antenna base and is arranged next to the helical antenna windings assigned exclusively to the AM-FM antenna in a second direction, wherein a slot running in the first direction is arranged at least in regions between the electrically conductive element and the helical antenna windings assigned exclusively to the AM-FM antenna in the circuit board.

8. The antenna module comprising an antenna unit as claimed in claim 1.

9. The antenna module as claimed in claim 8, wherein the antenna module comprises a protective cover arranged above a circuit board in a first direction, wherein a top-loading capacitance is arranged above the protective cover in the first direction.

10. The antenna module as claimed in claim 8, wherein the antenna module comprises at least one further antenna from a group of: an LTE 5G telephone antenna, a GNSS antenna, a V-to-X antenna, a WLAN antenna and a UWB antenna.

11. The motor vehicle having an antenna module as claimed in claim 8, wherein the antenna module is arranged at least partially on a motor vehicle roof of the motor vehicle, in particular under a shark fin cover of the motor vehicle roof.

12. The motor vehicle having an antenna module as claimed in claim 9, wherein the antenna module is arranged at least partially on a motor vehicle roof of the motor vehicle, in particular under a shark fin cover of the motor vehicle roof.

13. The motor vehicle having an antenna module as claimed in claim 10, wherein the antenna module is arranged at least partially on a motor vehicle roof of the motor vehicle, in particular under a shark fin cover of the motor vehicle roof.

14. The antenna module as claimed in claim 9, wherein the antenna module comprises at least one further antenna from the following group: an LTE 5G telephone antenna, a GNSS antenna, a V-to-X antenna, a WLAN antenna and a UWB antenna.

15. The motor vehicle having an antenna module as claimed in claim 14, wherein the antenna module is arranged at least partially on a motor vehicle roof of the motor vehicle, in particular under a shark fin cover of the motor vehicle roof.
